(19) United States
(12) Patent Application Publication
(10) Pub. No.: US 2014/0103163 A1
(43) Pub. Date: Apr. 17, 2014

(54) AIRCRAFT AND CABIN DOOR

(71) Applicant: LATECOERE, Toulouse (FR)

(72) Inventor: Patrick Lamat, Latecoere (FR)

(21) Appl. No.: 14/119,459

(22) PCT Filed: May 29, 2012
(86) PCT No.: PCT/EP2012/002260

§ 371 Date: Nov. 22, 2013

(30) Foreign Application Priority Data
May 31, 2011 (FR) 1154738

(51) Int. Cl. B64C 1/14

(52) U.S. Cl. CPC B64C 1/1461
USPC 244/129.5

(57) ABSTRACT

The invention relates to an aircraft including a cabin and a door panel (6) comprising, facing the lintel (5) of the opening (3), a sealing strip (13) having a heel piece (14) secured to the internal face of the door panel (6) and a flexible flap (15) that can deform elastically. In addition, the lintel (5) comprises a supporting face (21) for supporting the flexible flap (15), which face is set back from the profile of the fuselage (2) at the junction between the fuselage and the supporting face, such that, when the door panel (6) is in the closed position, the flexible flap (15) extends over the supporting face and matches the profile of the fuselage.

### CROSS REFERENCE TO RELATED APPLICATION

This application is a national stage entry of PCT/EP2012/002260 filed May 29, 2012, under the International Convention claiming priority over French Patent Application No. 1154738 filed May 31, 2011.

### FIELD OF THE INVENTION

The invention relates to an aircraft including a cabin delimited by a fuselage provided with at least one opening for access to said cabin, and to a device for blocking said opening.

### BACKGROUND OF THE INVENTION

At present, the solution almost universally adopted to meet all these constraints (door panel movement constraints, aerodynamic constraints, etc.) consists in the production of sealing lips having a heel piece designed to be fixed to the external face of the door panel along the top edge of said door panel and an elastically deformable flexible flap in line with said top edge.

Although, as already mentioned, such sealing lips have equipped almost all aircraft for decades, this solution nevertheless proves to have a major drawback. In fact, these sealing lips form a projection that is notably exposed to winds and to impacts and on the one hand are subject to accelerated ageing and on the other hand are subjected to loads tending to unstick them, reflected in proven risks of pulling them off. For these reasons, such sealing lips are found to lead to non-negligible maintenance costs.

The only solution proposed at present for alleviating these drawbacks consists in producing sealing lips of the type described in U.S. Pat. No. 5,282,338 having a heel piece adapted to be fixed inside the cabin to the frame structure of the door panel and a sealing facing adapted to come into contact with the internal face of said door panel. However, in the context of a door panel that has to undergo an initial opening phase to retract the abutment members of said door panel, this solution also proves to have a major drawback ruling out its use when the door panel is intended for access by personnel and/or passengers. In fact, this design makes it obligatory to leave between the frame structure and the door panel a volume that is directly exposed to external conditions. This volume fills with ice in flight at high altitude with the result that the door panel is “welded” to the frame structure, preventing opening of said door panel before significant thawing of said ice.

### SUMMARY OF THE INVENTION

The present invention aims to alleviate these drawbacks and the main objective of the present invention is to provide an aircraft in which the devices for blocking the access openings are designed so that the sealing lip is mechanically protected.

To be more specific, the invention is directed to aircraft with cabin access openings equipped with a conventional blocking device including:

a frame structure including two uprights, a first crossmember referred to as the threshold and a second crossmember referred to as the lintel,

a door panel having two longitudinal edges, a so-called bottom transverse edge adapted to rest on the threshold in a closed position of the door panel, blocking the opening, and a so-called top transverse edge adapted to be aligned vertically with the lintel in said closed position,

abutment members disposed on the door panel and on the frame structure so that the abutment members of the door panel are engaged against the abutment members of the frame structure in the closed position of the door panel,

means for guiding the door panel between its closed position and an open position providing access to the aircraft cabin by virtue of a movement including an initial opening phase during which the door panel is moved along a trajectory (rᵢ) for retracting the abutment members of the door panel from inter-engagement with the abutment members of the frame structure, and

sealing means disposed on the perimeter of the door panel.

Moreover, because of the initial opening phase intended to enable retraction of the abutments of the door panel:

a space is provided between the top edge of said door panel and the lintel of the frame structure,

the sealing means include a sealing lip provided with a flexible flap adapted to line up with the top edge of the door panel so as to come into contact with the fuselage and to bend elastically at the end of closing of said door panel in order to disturb the aerodynamics of the aircraft as little as possible.

It is to be noted that in the present application, for reasons of simplicity and clarity of the description, the terms top, bottom, threshold, lintel are used with reference to the principal direction of movement of the door panel during its initial opening phase that in practice, in the case of passenger access doors, corresponds to a substantially vertical upward direction. However, it is to be clearly understood that the invention is not limited to this initial direction of movement and the latter direction may be a horizontal direction, a downward vertical direction (the threshold then consisting of the top crossmember of the frame structure), etc.

Another objective of the invention is to provide aircraft in which the aerodynamics of the access openings are improved.

To this end, the invention is directed to an aircraft of the type described in the above preamble in which the access opening blocking devices include:

sealing means comprising, between the top edge of the door panel and the lintel of the frame structure, sealing members composed of a sealing lip including a heel piece fixed to the internal face of the door panel, along the top edge of said door panel, and an elastically deformable flexible flap in line with said top edge and having a prestressed natural state bent toward the fuselage,

a frame structure the lintel of which includes a bearing face for the flexible flap of the sealing lip set back relative to the profile of the fuselage at the level of the junction of the latter with said bearing face so that in the closed position of the door panel the flexible flap extends over said bearing face in a position straightened relative to its natural bent state in which it matches the profile of the fuselage,

the guide means for the door panel are adapted to move said door panel along an initial trajectory (rᵢ) substantially parallel to the tangent to the profile of the fuselage at the level of the junction of the latter with the bearing face for the flexible flap of the sealing lip.

Thus the invention has consisted not only in using a sealing lip adapted so that its heel piece is fixed to the internal face of the door panel and its flexible flap extends outside the fuselage, but also:

conforming the frame structure so that the flexible flap matches perfectly the profile of the fuselage and therefore does not form any projection with respect to the profile of said fuselage,

adapting the guide members so that the flexible flap can slide along the fuselage at the beginning of opening and at the end of closing without impact and therefore without risk of damaging said flexible flap.

The combination of these features leads to the production of blocking devices in which the sealing strips match perfectly the profile of the fuselage and on the one hand are therefore perfectly protected from the mechanical point of view and on the other hand do not disturb the aerodynamics of the fuselage.

In accordance with an advantageous embodiment of the invention, the bearing face for the flexible flap of the sealing lip and the fuselage at the level of its junction with said bearing face form an obtuse dihedron.

Moreover, the dihedron formed by the bearing face for the flexible flap of the sealing lip and the fuselage at the level of its junction with said bearing face advantageously has an apex of rounded shape.

These features aim in fact to improve the sliding of the flexible flap along the fuselage without impacts.

Moreover, the sealing lip advantageously includes a compressible sealing bead projecting relative to the heel piece and the flexible flap substantially at the level of the junction between them and the lintel then advantageously includes between the opening and the bearing face for the flexible flap a face for guiding and compressing the sealing bead.

A one-piece sealing lip therefore has aerodynamic and sealing functions.

Moreover, in accordance with another advantageous embodiment of the invention, the heel piece and the flexible flap of the sealing lip are connected by a connecting area with a double bend.

Furthermore, this area of connection between the heel piece and the flexible flap of the sealing lip advantageously delimits at the base of the flexible flap an external shoulder abutting against the edge of the door panel so that this edge is protected, such protection notably being of great benefit when the door panel is made of a composite material.

### BRIEF DESCRIPTION OF THE DRAWINGS

Other features, objects and advantages of the invention will emerge from the following detailed description with reference to the appended drawings, which show a preferred embodiment thereof by way of nonlimiting example. In these drawings:

FIGS. 1 and 2 are partial perspective views of a door panel (FIG. 1) and an access opening (FIG. 2) of an aircraft in accordance with the invention,

FIGS. 3 to 5 are vertical sections of the top part of an access opening and a door panel, respectively in a closed position of the door panel (FIG. 3), at the end of an initial opening phase (FIG. 4), and at the end of a second opening phase (FIG. 5), and

FIG. 6 consists of three diagrams representing the door panel guide means in three successive positions respectively corresponding to the three positions represented in FIGS. 3 to 5.

### DETAILED DESCRIPTION OF THE INVENTION

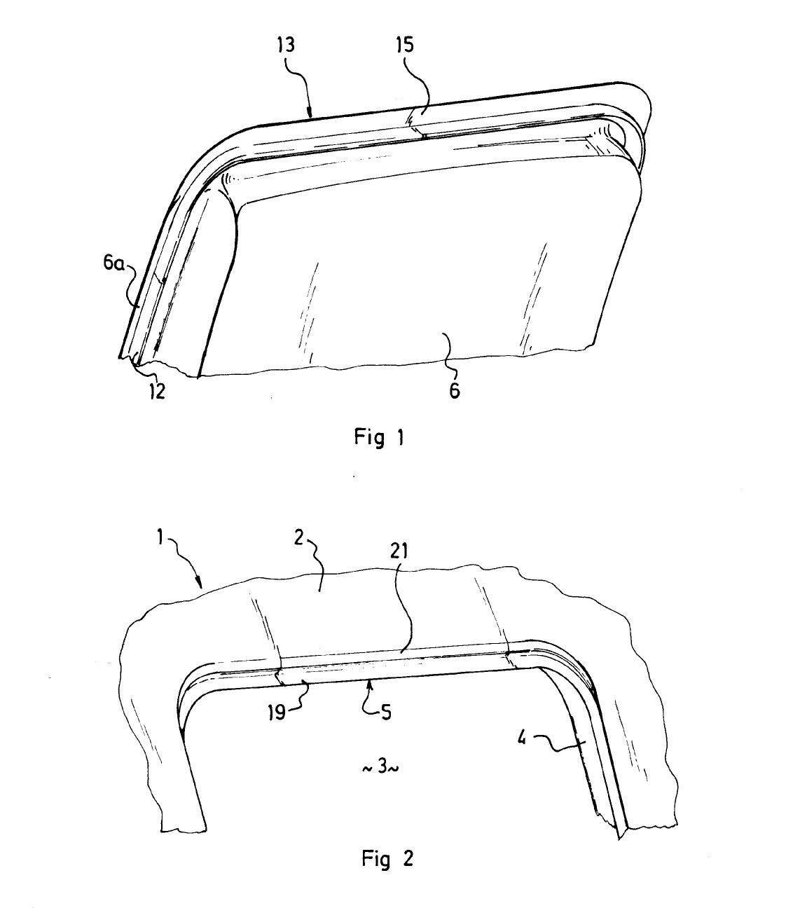

The invention as represented in FIGS. 1 and 2 relates to an aircraft including a cabin 1 delimited by a fuselage 2 provided with access openings to said cabin, such as the opening 3 represented in FIG. 2 intended for access by personnel and passengers, equipped with devices for blocking said openings including, in the usual way:

a frame structure 4 including a threshold crossmember and a crossmember 5 forming a lintel,

a door panel 6 having a plane peripheral strip 6a including a bottom transverse edge adapted to rest on the threshold in a closed position of the door panel 6, blocking the opening 3, and a top transverse edge, adapted to be at a distance from and aligned vertically with the lintel 5 in said closed position,

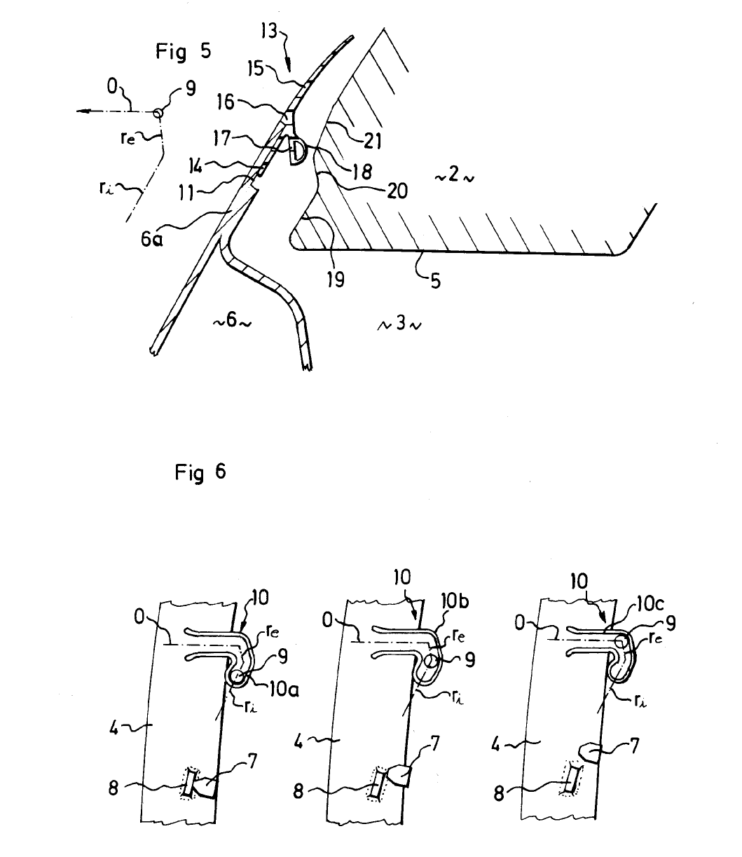

abutment members 7, 8 disposed on the door panel 6 and on the frame structure 4 so that, as FIG. 6 shows, the abutment members 7 of the door panel 6 are engaged against the abutment members 8 of the frame structure 4 in the closed position of the door panel 6,

means for guiding the door panel 6 between its closed position and an open position providing access to the aircraft cabin 1, and

sealing means disposed on the perimeter of the door panel 6.

Moreover, as represented in FIG. 6, the guide means include guide pins 9 fastened to the door panel 6 and disposed so as to move inside a track formed on a guide member 10 fastened to the frame structure 4, said track defining a movement including:

an initial opening phase defined by a first track section 10a, during which the door panel 6 is moved along an inclined upward trajectory (rᵢ) in the direction of the interior of the cabin 1, enabling retraction of the abutment members 7 of the door panel 6 from inter-engagement with the abutment members 8 of the frame structure 4,

an intermediate phase defined by a second track section 10b, during which the door panel 6 is moved along an inclined upward trajectory (rₑ) in the direction of the exterior of the cabin 1, enabling movement of the abutment members 7 of the door panel 6 into a high position in which they are offset in the upward direction relative to the abutment members 8 of the frame structure 4, and

a final opening phase defined by a third track section 10c, during which the door panel 6 is moved along a horizontal trajectory (0) enabling it to be folded against the fuselage 2.

It is to be noted that, during closing of the door panel 6, the latter is moved along a reverse trajectory, the initial closing phase corresponding to the final opening phase and the final closing phase corresponding to the initial opening phase.

For their part, the sealing means comprise, along the uprights and the bottom transverse edge of the door panel 6, a seal 12 of the usual type known in itself which is therefore not described in detail in the present application.

These sealing means further comprise a sealing lip 13 adapted to extend along the top transverse edge of the door panel 6 and to be extended on either side of said top edge along a top end section of each upright.

To be specific, this sealing lip 13 includes:

a heel piece 14 for fixing it in a rebate 1 provided in the internal face of the top edge of the door panel 6,

an elastically deformable flexible flap 15 adapted to line up with said top edge of the door panel 6 and having a prestressed natural state bent in the direction of the fuselage 2,

an intermediate connecting area 16 between the heel piece 14 and the flexible flap 15 comprising a double bend and notably delimiting at the base of the flexible flap 15 an external shoulder abutting against the edge of the door panel 6, and

an oblique flange 17 on which is formed a compressible sealing bead 18 projecting relative to the internal faces of the heel piece 14 and the flexible flap 15, substantially at the level of the junction between the latter.

Furthermore, this sealing lip 13 is advantageously constituted of a strong and flexible core consisting of a blade made from composite material or stainless steel embedded in a mass of silicone, for example.

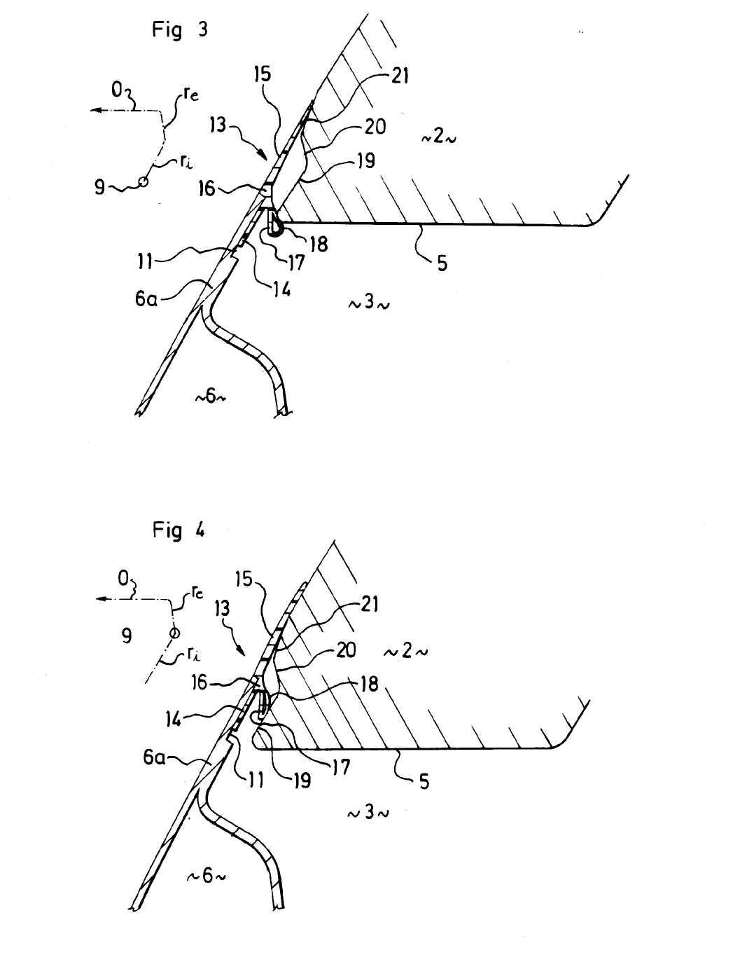

Facing the sealing lip 13, for its part, the lintel 5 includes an external face conformed so as to feature, as represented in FIGS. 3 to 5:

directly above the opening 3, a bottom face 19 substantially parallel to the door panel 6 for guiding and compressing the sealing bead 18, at the level of the bottom end of which said sealing bead is held compressed in the closed position of the door panel 6, and along which this sealing bead 18 is made to slide, notably during the initial opening phase and the final closing phase,

an intermediate face 20 delimiting with the bottom face 19 an “open” V-shaped groove with an angle at the apex of the order of 130° to 140°, and

a top bearing face 21 for the flexible flap 15 of the sealing lip 13 forming with the fuselage 2, at the level of the junction of the latter with said bearing face, an obtuse dihedron having an apex of rounded shape and the angle at the apex of which, being a function notably of the profile of the fuselage at the level of this junction, is adapted so that, in the closed position of the door panel 6 represented in FIG. 3, the flexible flap 15 extends over the top bearing face 21 in a position straightened relative to its natural bent state and in which it matches the profile of the fuselage 2.

Finally, the parts 10 for guiding the door panel 6 are adapted to move said door panel along an initial trajectory (rᵢ) substantially parallel to the tangent to the profile of the fuselage 2 at the level of the junction of the latter with the top bearing face 21 for the flexible flap 15 of the sealing lip 13, which proves to correspond substantially to the tangent to the profile of the fuselage 2 along the free edge of the flexible flap 15 of the sealing lip 13.

Accordingly, during the initial phase of opening the door panel 6 the flexible flap 15 is made to slide along the fuselage 2 without impacts.

Such a kinematic combined with the method of fixing the heel piece 14 of the sealing lip 13 and the conformation of the lintel 5 leads to the production of blocking devices in which the sealing lips 13 match perfectly the profile of the fuselage 2 and on the one hand are therefore perfectly protected from the mechanical point of view and on the other hand do not disturb the aerodynamics of said fuselage.

1. An aircraft comprising:
a cabin (1) delimited by a fuselage (2) provided with at least one opening (3) providing access to said cabin and a device for blocking said opening including:
a frame structure (4) including two uprights, a first crossmember referred to as the threshold and a second crossmember (5) referred to as the lintel,
a door panel (6) having two longitudinal edges, a so-called bottom transverse edge adapted to rest on this threshold in a closed position of the door panel (6), blocking the opening (3), and a so-called top transverse edge adapted to be aligned vertically with the lintel (5) in said closed position,
abutment members (7, 8) disposed on the door panel (6) and on the frame structure (4) so that the abutment members (7) of the door panel (6) are engaged against the abutment members (8) of the frame structure (4) in the closed position of the door panel (6),
a guiding device (9, 10) for guiding the door panel (6) between its closed position and an open position providing access to the aircraft cabin (1) by virtue of a movement including an initial opening phase during which the door panel is moved along a trajectory (n) for retracting the abutments (7) of the door panel (6) from inter-engagement with the abutment members (8) of the frame structure (4), and
a sealing device (12, 13) disposed on the perimeter of the door panel (6),
said aircraft being characterized in that, for each opening (3) providing access to the cabin (1):
the sealing device comprise, between the top edge of the door panel (6) and the lintel (5) of the frame structure (4), sealing device composed of a sealing lip (13) including a heel piece (14) fixed to the internal face of the door panel (6), along the top edge of said door panel, and an elastically deformable flexible flap (15) in line with said top edge and having a prestressed natural state bent toward the fuselage (2),
the lintel (5) of the frame structure (4) includes a bearing face (21) for the flexible flap (15) of the sealing lip (13) set back relative to the profile of the fuselage (2) at the level of the junction of the latter with said bearing face so that in the closed position of the door panel (6) the flexible flap (15) extends over said bearing face in a position straightened relative to its natural bent state and in which it matches the profile of the fuselage (2),
the guide device (9, 10) for the door panel (6) are adapted to move said door panel along an initial trajectory (rᵢ) substantially parallel to the tangent to the profile of the fuselage (2) at the level of the junction of the latter with the bearing face (21) for the flexible flap (15) of the sealing lip (13).

2. The aircraft as claimed in claim 1, wherein the bearing face (21) for the flexible flap (15) of the sealing lip (13) and the fuselage (2) at the level of its junction with said bearing face form an obtuse dihedron.

3. The aircraft as claimed in claim 2, wherein the dihedron formed by the bearing face (21) for the flexible flap (15) of the sealing lip (13) and the fuselage (2) at the level of its junction with said bearing face has an apex of rounded shape.

4. The aircraft as claimed in claim 1, wherein:
the sealing lip (13) includes a compressible sealing bead (17, 18) projecting relative to the heel piece (14) and the flexible flap (15) substantially at the level of the junction between the latter,
the lintel (4) includes between the opening (3) and the bearing face (21) for the flexible flap (15) a face (19) for guiding and compressing the sealing bead (17, 18).

5. The aircraft as claimed in claim 1, wherein the heel piece (14) and the flexible flap (15) of the sealing lip (13) are connected by a connecting area (16) comprising a double bend.

6. The aircraft as claimed in claim 5, wherein the connecting area (16) between the heel piece (14) and the flexible flap (15) of the sealing lip (13) delimits at the base of the flexible flap (15) an external shoulder abutting against the edge of the door panel (6).
